(19) United States
(12) Patent Application Publication
(10) Pub. No.: US 2026/0055021 A1
(43) Pub. Date: Feb. 26, 2026

(54) Architectural Glass for Greenhouses

(71) Applicant: Vitro Flat Glass LLC, Cheswick, PA (US)

(72) Inventor: Farzad Fareed, San Diego, CA (US)

(21) Appl. No.: 19/225,934

(22) Filed: Jun. 2, 2025

Related U.S. Application Data
(60) Provisional application No. 63/655,624, filed on Jun. 4, 2024.

(51) Int. Cl. C03C 17/36; A01G 9/18

(52) U.S. Cl. CPC C03C 17/366; A01G 9/18; C03C 17/3607; C03C 17/3644; C03C 2218/156

(57) ABSTRACT

An architectural glass for use in a greenhouse comprising a substrate having a coating, the coating comprising a first dielectric layer, a metal layer over the first dielectric layer, a second dielectric layer over the metal layer, and a first protective overcoat over the second dielectric layer, wherein the first protective overcoat comprises silica and alumina. A back surface of the glass substrate can be coated with a scattering layer and a second protective overcoat. The architectural glass can be a monolithic glass or a component in an insulated glass unit. A method of increasing photosynthesis efficiencies in an insulated glass unit to greater than 88%, greater than 90%, or greater than 93% is also disclosed.

### CROSS-REFERENCE TO RELATED PATENT APPLICATIONS

This application claims the benefit of U.S. Provisional Patent Application No. 63/655,624, filed Jun. 4, 2024, which is incorporated herein by reference in its entirety.

### BACKGROUND OF THE INVENTION

### Field of the Invention

The invention relates to architectural glass, such as used in monolithic or multi-pane insulated glass units, and more particularly, to architectural glass having a coating profile that is optimized for greenhouse applications to maximize the photosynthesis process and energy requirements of a greenhouse.

### Description of Related Art

The future of urban agriculture may rely on high-rise greenhouse buildings in a variety of climates to grow fresh produce. Modern greenhouse production is referred to as controlled environment agriculture (CEA). With the use of a greenhouse, it is possible to cultivate food-producing plants in locations and at times when climatic conditions would adversely affect them or even prevent them from growing. The controlled environment increases the growth efficiency and reduces the water consumption. The current technology is mostly based on transparent plastic sheets, but the use of glass to increase efficiency is becoming more popular. One challenge currently being faced is the ability to reduce the large energy consumption used in cold environments and/or to reduce the large amount of energy consumption needed to combat excess heat in warm climates.

Typically, architectural glass is designed to be aesthetically pleasing and to include solar control coatings that block or filter selected ranges of electromagnetic radiation to reduce the amount of solar energy entering the building reducing the load on the cooling units of the building. This is especially desirable in warmer climates. Insulated glass units, which comprise two or more panes of glass separated by an inert gas, are often used to control heat conductance across a window structure and are designed to keep buildings warmer in the winter and cooler in the summer. In colder climates, there is a need for an architectural glass that has a high solar heat gain coefficient (SHGC) and a low overall heat transfer coefficient (U-value) that traps the solar energy in the building to help reduce the load on the heating units needed to heat the buildings. The SHGC is the fraction of incident solar radiation admitted through a window, both directly transmitted, and absorbed and subsequently released inwardly. The lower the SHGC, the less solar heat is transmitted. The U-value is a measure of the rate of non-solar heat loss or gain through a material. The lower the U-value, the greater the resistance to heat flow and the better the insulating value.

The combination of a glass having a high SHGC and having a coating design that optimizes the photosynthesis process with either a monolithic glass or with an insulated glass unit for controlling heat conductance across the window to trap solar energy within a building would be especially desirable in the construction of greenhouses as it would allow for the production of fresh produce year-round.

### SUMMARY OF THE INVENTION

In accordance with one aspect, the present disclosure is directed to an architectural glass for use in a greenhouse comprising a substrate having a coating, the coating comprising a first dielectric layer, a metal layer over the first dielectric layer, a second dielectric layer over the metal layer, and a first protective overcoat over the second dielectric layer, wherein the first protective overcoat comprises silica and alumina. The coating is located on one side of the substrate. A scattering layer and a second protective overcoat can be located on the opposite side of the substrate. The metal layer can be a single silver layer. The coating is configured to maximize and achieve uniform plant growth. The glass can have a photosynthesis efficiency of greater than approximately 88%, greater than approximately 90%, or greater than approximately 93%.

According to one embodiment, the architectural glass can be a monolithic laminated architectural glass. According to another embodiment, the architectural glass can be used in an insulated glass unit.

In accordance with another aspect, the present disclosure is directed to an architectural insulating glass unit comprising a first substrate having a No. 1 surface and a No. 2 surface; a second substrate having a No. 3 surface and a No. 4 surface, wherein the second substrate is spaced from the first substrate, and wherein the first and second substrate are associated with each other to define gap therebetween, wherein the No. 2 surface and the No. 3 surface are oppositely disposed from each other and define the gap between the first substrate and the second substrate; a coating located on the No. 2 surface, the No. 3 surface, or the No. 4 surface, the coating comprising a first dielectric layer, a metal layer over the first dielectric layer, a second dielectric layer over the metal layer, and a first protective overcoat over the second dielectric layer, wherein the first protective overcoat comprises silica and alumina. A scattering layer can be located on at least one of the No. 1, the No. 2, the No. 3, or the No. 4 surface, wherein the scattering layer is located on one of the No. 1, No. 2, No. 3, and No. 4 surface that is different than the surface having the coating thereon. A second protective overcoat can be located over the scattering layer, wherein the second protective overcoat comprises silica and alumina.

According to one embodiment, the architectural insulating glass unit can have a photosynthesis efficiency of greater than approximately 88%, greater than approximately 90%, or greater than approximately 93%.

In accordance with another aspect, the present disclosure is directed to a method of increasing photosynthesis efficiencies in an insulated glass unit for use in a greenhouse comprising; passing sunlight through an architectural glass comprising a substrate and a coating over at least a portion of the substrate, wherein the coating comprises a first dielectric layer, a metal layer over the first dielectric layer, a second dielectric layer over the metal layer, and a protective overcoat over the second dielectric layer, wherein the first protective overcoat comprises silica and alumina. A scattering layer and a second protective overcoat can be applied to a surface of the substrate that is opposite to the coating, wherein the second protective overcoat comprises silica and alumina.

According to one embodiment, the architectural insulating glass unit can have a photosynthesis efficiency of greater than approximately 88%, greater than approximately 90%, or greater than approximately 93%.

### BRIEF DESCRIPTION OF THE DRAWINGS

The invention is illustrated in the accompanying drawing figures, wherein like reference characters identify like parts throughout. Unless indicated to the contrary, the drawing figures are not to scale.

FIG. 1 is a partial side view of monolithic glass showing an arrangement of the applied layers in accordance with an embodiment of the invention.

FIG. 2A is a partial side view of a multi-pane insulated glass unit showing one arrangement of the applied layers in accordance with an embodiment of the invention.

FIG. 2B is a partial side view of a multi-pane insulated glass unit showing another arrangement of the applied layers in accordance with an embodiment of the invention.

FIG. 3A is a graph illustrating the absorptance at various wavelengths of red and green leaves in accordance with an embodiment of the invention.

FIG. 3B is a graph illustrating the relative quantum efficiency at various wavelengths of red and green leaves in accordance with an embodiment of the invention.

FIG. 3C is a graph illustrating the digitized results of the graph of FIG. 3B in accordance with an embodiment of the invention.

FIG. 3D is a graph illustrating the relative quantum efficiency for red leaves interpolated to wavelengths ranging from 405-720 nm, commonly used in optical modeling software in accordance with an embodiment of the invention.

FIG. 3E is a graph illustrating the relative quantum efficiency for green leaves interpolated and extrapolated beyond the literature data to obtain a complete set of data for wavelengths ranging from 300 to 730 nm in accordance with an embodiment of the invention.

FIGS. 4A-4H are graphs illustrating the percentage of transmission at various wavelengths corresponding to the glass substrate samples set forth in Examples 1-8 and Tables 5-12.

FIG. 5 is a schematic view of the layers of the glass substrate discussed in Example 7 and Table 11.

FIG. 6 is a schematic view of the layers of the glass substrate discussed in Example 8 and Table 12.

FIG. 7 is a bar graph illustrating the photosynthesis efficiency of various types of glass in accordance with an embodiment of the invention.

FIG. 8 is a bar graph illustrating the reflectance and absorption of various types of glass in accordance with an embodiment of the invention.

### DESCRIPTION OF THE INVENTION

As used herein, spatial or directional terms, such as “left”, “right”, “upper”, “lower”, “inner”, “outer”, “above”, “below”, and the like, relate to the invention as it is shown in the drawing figures. However, it is to be understood that the invention can assume various alternative orientations and, accordingly, such terms are not to be considered as limiting. Further, as used herein, all numbers expressing dimensions, physical characteristics, processing parameters, quantities of ingredients, reaction conditions, and the like, used in the specification and claims are to be understood as being modified in all instances by the term “about”. Accordingly, unless indicated to the contrary, the numerical values set forth in the following specification and claims may vary depending upon the desired properties sought to be obtained by the present invention. At the very least, and not as an attempt to limit the application of the doctrine of equivalents to the scope of the claims, each numerical value should at least be construed in light of the number of reported significant digits and by applying ordinary rounding techniques. Moreover, all ranges disclosed herein are to be understood to encompass the beginning and ending range values and any and all subranges subsumed therein. For example, a stated range of “1 to 10” should be considered to include any and all subranges between (and inclusive of) the minimum value of 1 and the maximum value of 10; that is, all subranges beginning with a minimum value of 1 or more and ending with a maximum value of 10 or less, e.g., 1 to 3.3, 4.7 to 7.5, 5.5 to 10, and the like. Additionally, all documents, such as but not limited to, issued patents and patent applications, referred to herein are to be considered to be “incorporated by reference” in their entirety. Any reference to amounts, unless otherwise specified, is “by weight percent”.

As used herein, the terms “formed over”, “deposited over”, or “provided over” mean formed, deposited, or provided on but not necessarily in contact with the surface. For example, a coating layer “formed over” a substrate does not preclude the presence of one or more other coating layers or films of the same or different composition located between the formed coating layer and the substrate. The terms “visible region” or “visible light” refer to electromagnetic radiation having a wavelength in the range of 380 nm to 800 nm. The terms “infrared region” or “infrared radiation” refer to electromagnetic radiation having a wavelength in the range of greater than 800 nm to 100,000 nm. The terms “ultraviolet region” or “ultraviolet radiation” mean electromagnetic energy having a wavelength in the range of 300 nm to less than 380 nm. Additionally, all documents, such as, but not limited to, issued patents and patent applications, referred to herein are to be considered to be “incorporated by reference” in their entirety. As used herein, the term “film” refers to a coating region of a desired or selected coating composition. A “layer” can comprise one or more “films”, and a “coating” or “coating stack” can comprise one or more “layers”. U-values herein are expressed for NFRC/ASHRAE winter conditions of 0° F. (−18° C.) outdoor temperature, 70° F. (21° C.) indoor temperature, 15 miles per hour wind, and no solar load.

All documents referred to herein are to be considered to be “incorporated by reference” in their entirety.

The discussion of the invention herein may describe certain features as being “particularly” or “preferably” within certain limitations (e.g., “preferably”, “more preferably”, or “even more preferably”, within certain limitations). It is to be understood that the invention is not limited to these particular or preferred limitations but encompasses the entire scope of the disclosure.

As used herein, the transitional term “comprising” (and other comparable terms, e.g., “containing” and “including”) is “open-ended” and open to the inclusion of unspecified matter. Although described in terms of “comprising”, the terms “consisting essentially of” and “consisting of” are also within the scope of this disclosure.

The invention comprises, consists of, or consists essentially of, the following aspects of the invention, in any combination. Various aspects of the invention are illustrated in separate drawing figures. However, it is to be understood that this is simply for case of illustration and discussion. In the practice of the invention, one or more aspects of the invention shown in one drawing figure can be combined with one or more aspects of the invention shown in one or more of the other drawing figures.

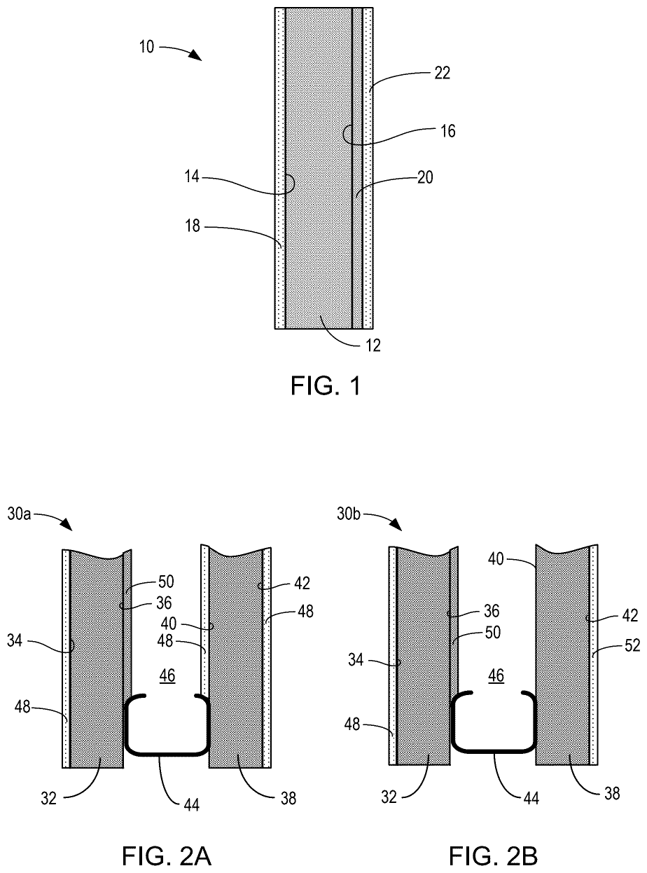

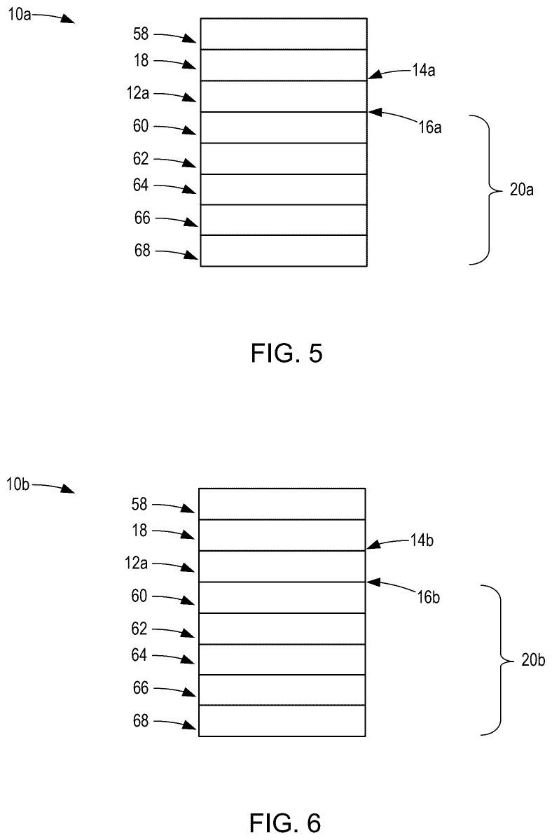

Reference is now made to FIG. 1, which shows a partial side view of the monolithic glass structure, generally indicated as 10, showing an arrangement of the applied coatings in accordance with an embodiment of the invention. The glass structure 10 comprises a substrate 12 having a first side 14 and a second side 16. An anti-reflective scattering layer 18 is located on the first side 14 of the substrate 12. A coating 20 is located on the second side 16 of the substrate 12. With reference to FIGS. 5 and 6, the coating 20, indicated as 20a, 20b in FIGS. 5 and 6, can include a first dielectric layer 60, a metal layer 62 over the first dielectric layer 60, a second dielectric layer 66 over the metal layer 62, and a first protective overcoat 68 over the second dielectric layer 66. A primer layer 64 can be located over the metal layer 62. According to one embodiment, the second coating 20 can be a low e-coating layer applied using a chemical vapor deposition (CVD) process, a magnetron sputtering vapor deposition (MSVD) process, and the like process.

According to one embodiment, the scattering layer 18 can be designed to impart a haze of at least 20% to the glass structure 10. With reference to FIGS. 5 and 6, a second protective overcoat 58 can be applied over the scattering or first layer 18. The second protective overcoat 58, can be silica and alumina. For example, the first and second protective overcoat 68, 58 can have at least 50 volume % silica; 50 to 99 volume % silica and 50 to 1 volume % alumina; 60 to 98 volume % silica and 40 to 2 volume % alumina; 70 to 95 volume % silica and 30 to 5 volume % alumina; 80 to 90 weight % silica and 10 to 20 weight % alumina, or 85 weight % silica and 15 weight % alumina.

A protective layer 22, such as a glass frit and/or paint slurry layer, can be provided adjacent to the coating or low-e layer 20. According to one embodiment, the glass frit and/or paint slurry layer protective layer 22 can be applied and then tempered to melt the glass frit and completely encapsulate the low-e coating layer. The scattering layer 18 and the coating 20 cooperate together to create a coating profile on the substrate 12 to produce a glass structure that maximizes and achieves uniform plant growth. The glass structure 10 is particularly suitable for use in the construction of greenhouses.

Reference is now made to FIG. 2A, which shows a partial side view of a multi-pane architectural insulated glass unit, generally indicated as 30a, according to one embodiment of the present invention. The insulating glass unit 30a includes a first substrate 32 having a No. 1 surface 34 and a No. 2 surface 36. The insulating glass unit 30a also includes a second substrate 38 having a No. 3 surface 40 and a No. 4 surface 42. The second substrate 38 is spaced from the first substrate 32 via a spacer frame 44 to define a gap 46 therebetween, wherein the No. 2 surface 36 and the No. 3 surface 40 are oppositely disposed from each other and define the gap 46 between the first substrate 32 and the second substrate 38. The gap 46 between the first substrate 32 and the second substrate 38 can be filled with air or a non-reactive gas. The glass unit 30A further includes an anti-reflective scattering layer 48. According to one embodiment, the scattering layer 48 can have a haze of at least 20%. The scattering layer 48 can be located on one or more of the No. 1 surface 34, the No. 3 surface 40, or the No. 4 surface 42. The glass unit 30 also includes a second layer comprising a low-e layer 50, which can be located on the No. 2 surface 36.

Reference is now made to FIG. 2B which shows a partial side view of a multi-pane architectural insulated glass unit, generally indicated as 30b, according to another embodiment of the present invention. This embodiment is similar to the embodiment shown in FIG. 2A, and like reference numerals are used to indicate like components of the unit. The insulating unit 30b differs from the insulating unit 30a of FIG. 2A in that a glass frit layer 52 is located on the No. 4 surface 42, and only a single scattering layer 48 is shown, which is located on the No. 1 surface.

It can be appreciated that although the embodiments of FIGS. 2A and 2B show the low-e coating 50 located on the No. 2 surface, the low-e coating could, alternatively, be located on the No. 3 surface 40 or the No. 4 surface 42. It can also be appreciated that the scattering layer 48 can be positioned on one or more of any of the No. 1 surface 34, the No. 2 surface 36, the No. 3 surface 40, and the No. 4 surface 42, as long as this scattering layer 48 is not on the same surface as the low-e coating 50. According to one embodiment, the low-e coating 50 can be located on either the No. 2 surface or the No. 3 surface, and the scattering layer 48 can be positioned on the No. 1 or the No. 4 surface.

It can be appreciated that the first substrate 32 and the second substrate 38 can be connected together by any suitable manner, such as by being adhesively bonded to a conventional spacer frame 44, as discussed above and as is known in the art. According to one embodiment, the gap 46 can be filled with a selected atmosphere, such as gas, for example, air, or a non-reactive gas such as argon or krypton gas. According to another embodiment, the gap 46 may be evacuated to produce a vacuum (a vacuum-insulating glass unit). Additionally, or alternatively to being vacuum filled or gas filled, the gap 46 may contain a liquid, gel, solid, or combination thereof. The gap may also contain a mechanical structure, such as movable blinds. Examples of insulating glass units are found, for example, in U.S. Pat. Nos. 4,193,236; 4,464,874; 5,088,258; and 5,106,663.

The scattering layer 18, 48 and the low-e coatings 20, 50 as described herein can be applied by any useful method, such as, but not limited to, conventional chemical vapor deposition (CVD) and/or physical vapor deposition (PVD) methods. Examples of CVD processes include spray pyrolysis. Examples of PVD processes include electron beam evaporation and vacuum sputtering (such as magnetron sputter vapor deposition (MSVD)). Other coating methods could also be used, such as, but not limited to, sol-gel deposition, slot die coating deposition, or printing depositions, such as screen printing or inkjet printing. In one non-limiting embodiment, the scattering layer 18, 48 and low-e coating 20, 50 are deposited by MSVD. Examples of MSVD coating devices and methods will be well understood by one of ordinary skill in the art and are described, for example, in U.S. Pat. Nos. 4,379,040; 4,861,669; 4,898,789; 4,898,790; 4,900,633; 4,920,006; 4,938,857; 5,328,768; and 5,492,750.

According to one embodiment, the metal layer 62 of the low-e coating layer 20 can comprise a single metallic layer, such as a silver layer, a copper layer, a nickel chromium layer, an aluminum layer, or any other highly conductive material. Alternatively, a transparent conductive oxide layer (TCO) can be used in the low-e coating layer, such as gallium-doped zinc oxide (“GZO”), aluminum-doped zinc oxide (“AZO”), indium-doped zinc oxide (“IZO”) magnesium-doped zinc oxide (“MZO”), or tin-doped indium oxide (“ITO”). The silver layer can have a thickness of at least 6.5 nm and at most 20 nm. The glass substrate can be clear glass or an ultra-clear, low-iron glass. According to one embodiment, the substrate can comprise a glass as disclosed in U.S. Pat. Nos. 4,745,347; 4,792,536; 5,030,594; 5,030,593; 5,030,594; 5,240,886; 5,385,872; 5,393,593; 6,962,887 or 11,261,112; or U.S. patent application Ser. No. 16/782,130, which are incorporated by reference. Non-limiting examples of glass that can be used for the practice of the invention include clear glass, Starphire®, Solargreen®, Solextra®, GL-20®, GL-35™, Solarbronze®, Solargray® glass, Pacifica® glass, SolarBlue® glass, and Optiblue® glass, all commercially available from Vitro Flat Glass of Pittsburgh, Pa.

The particular coating profile of the monolithic glass structure 10 and the insulated glass units 30A, 30B results in a photosynthesis efficiency of greater than approximately 88%, greater than approximately 90%, or greater than approximately 93%. The photosynthesis efficiency was calculated by the following formula, comparing the plant growth with light passing through the glass and coating with that under unobstructed direct sunlight:

$$Photosynthesis efficiency = 100 \frac{\sum T ( λ ) S ( λ ) P ( λ )}{\sum S ( λ ) P ( λ )}$$

where T(λ) is the transmission, S(λ) is the solar intensity and P(λ) is the relative photosynthesis efficiency.
The silver layer was constrained so it would not go below 6.5 nm.
The results are listed in Table 1 below, wherein T stands for the transmitted color, Rf stands for the reflected color from the film side, and Rg stands for the reflected color from the glass side.

TABLE 1

| | current | | margin | Norm. | Weight | |
|---|---|---|---|---|---|---|
| Property | value | Target | (+/−) | factor | factor | Error |
| 8-RfL | 10.71 | 29.80 | 0 | 1.00 | 0.00 | 0.000 |
| 8-Rfa | 12.19 | −0.60 | 0 | 1.00 | 0.00 | 0.000 |
| 8-Rfb | 1.16 | −4.00 | 0 | 1.00 | 0.00 | 0.000 |
| 8-RfL | 11.92 | 31.90 | 0 | 1.00 | 0.00 | 0.000 |
| 8-Rga | 10.97 | −1.50 | 0 | 1.00 | 0.00 | 0.000 |
| 8-Rgb | 0.98 | −6.30 | 0 | 1.00 | 0.00 | 0.000 |
| 8-TL | 98.14 | 94.80 | 0 | 1.00 | 0.00 | 0.000 |
| 8-Ta | −1.25 | −1.20 | 0 | 1.00 | 0.00 | 0.000 |
| 8-Tb | 0.58 | 1.40 | 0 | 1.00 | 0.00 | 0.000 |
| 60-TL | 92.80 | 90.40 | 0 | 1.00 | 0.00 | 0.000 |
| 60-Ta | −0.45 | −0.30 | 0 | 1.00 | 0.00 | 0.000 |
| 60-Tb | −2.21 | 0.40 | 0 | 1.00 | 0.00 | 0.000 |
| LTA | 94.98 | 0.00 | 0 | 1.00 | 0.00 | 0.000 |
| Photosynthesis | 93.29 | 100.00 | 0 | 1.00 | 0.00 | 0.000 |

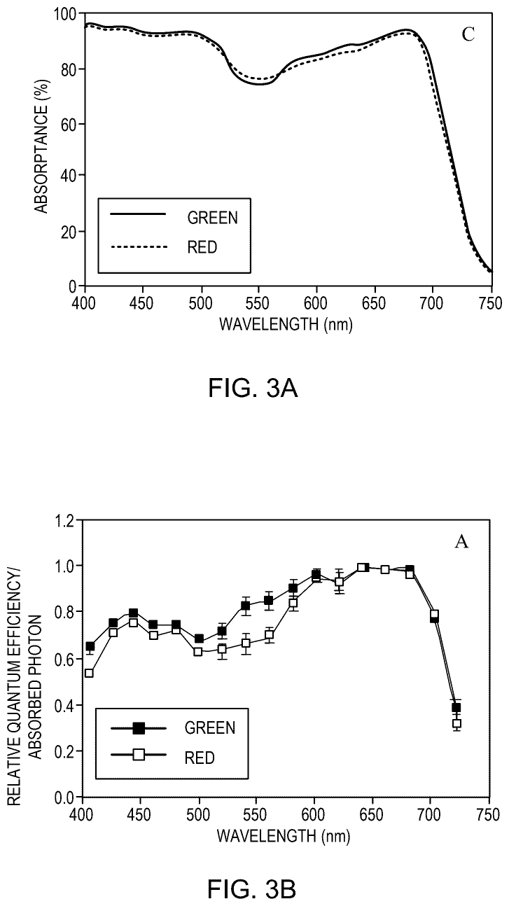

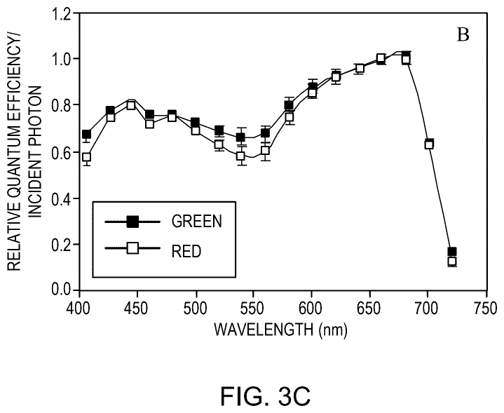

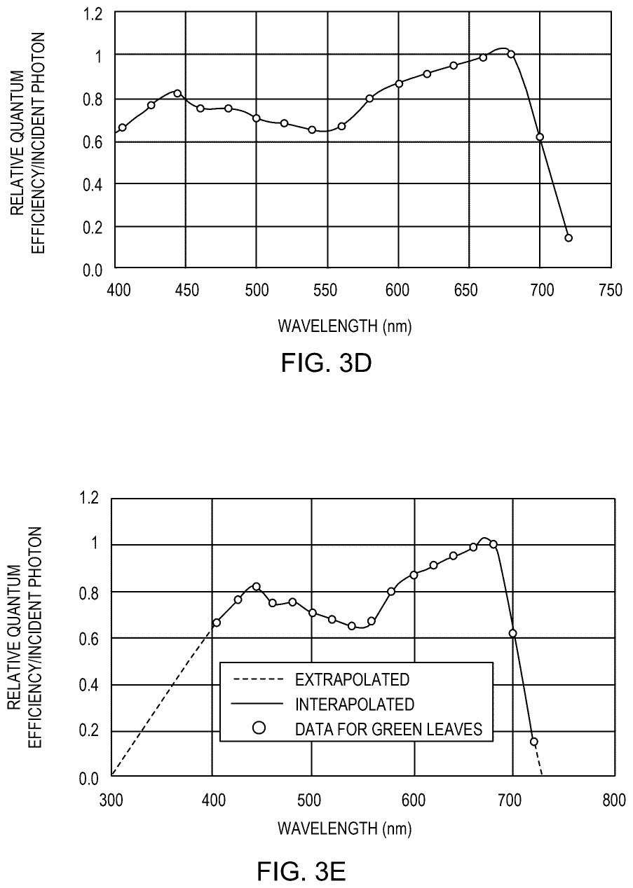

Reference is made to FIG. 3A which shows a graph illustrating the absorptance at various wavelengths of red and green leaves. FIG. 3B shows a graph illustrating the relative quantum efficiency at various wavelengths of red and green leaves in accordance with an embodiment of the invention and FIG. 3C shows a graph illustrating the digitized results of the graph of FIG. 3B in accordance with an embodiment of the invention. The values used for the graphs of FIGS. 3B and 3C are shown in Table 2, below.

TABLE 2

| Wavelength | | |
|---|---|---|
| (nm) | Green | Red |
| 405 | 0.665 | 0.56 |
| 426 | 0.765 | 0.73 |
| 445 | 0.82 | 0.79 |
| 460 | 0.75 | 0.72 |
| 480 | 0.755 | 0.74 |
| 500 | 0.71 | 0.68 |
| 520 | 0.68 | 0.62 |
| 539 | 0.65 | 0.58 |
| 560 | 0.67 | 0.59 |
| 580 | 0.8 | 0.75 |
| 600 | 0.87 | 0.85 |
| 620 | 0.91 | 0.91 |
| 640 | 0.95 | 0.95 |
| 660 | 0.99 | 0.99 |
| 680 | 1.005 | 0.99 |
| 700 | 0.62 | 0.62 |
| 720 | 0.15 | 0.11 |

FIG. 3D is a graph illustrating the relative quantum efficiency for red leaves interpolated to wavelengths ranging from 405-720 nm, commonly used in optical modeling software. The values used in the graph of FIG. 3D are shown in Table 3, below.

TABLE 3

| Wavelength | Red leave |
|---|---|
| (nm) | efficiency |
| 405 | 0.665 |
| 410 | 0.687817 |
| 415 | 0.710992 |
| 420 | 0.734883 |
| 425 | 0.759847 |
| 430 | 0.785705 |
| 435 | 0.808305 |
| 440 | 0.821717 |
| 445 | 0.82 |
| 450 | 0.800375 |
| 455 | 0.772702 |
| 460 | 0.75 |
| 465 | 0.741941 |
| 470 | 0.744802 |
| 475 | 0.751512 |
| 480 | 0.755 |
| 485 | 0.749987 |
| 490 | 0.738362 |
| 495 | 0.723806 |
| 500 | 0.71 |
| 505 | 0.699751 |
| 510 | 0.692374 |
| 515 | 0.68631 |
| 520 | 0.68 |
| 525 | 0.672317 |
| 530 | 0.663863 |
| 535 | 0.655671 |
| 540 | 0.648776 |
| 545 | 0.644561 |
| 550 | 0.645184 |
| 555 | 0.65291 |
| 560 | 0.67 |
| 565 | 0.697511 |
| 570 | 0.731669 |
| 575 | 0.767493 |
| 580 | 0.8 |
| 585 | 0.825347 |
| 590 | 0.844236 |
| 595 | 0.858507 |
| 600 | 0.87 |
| 605 | 0.880321 |
| 610 | 0.890139 |
| 615 | 0.899887 |
| 620 | 0.91 |
| 625 | 0.920713 |
| 630 | 0.93146 |
| 635 | 0.941478 |
| 640 | 0.95 |
| 645 | 0.953828 |
| 650 | 0.96402 |
| 655 | 0.974203 |
| 660 | 0.99 |
| 665 | 1.011586 |
| 670 | 1.029333 |
| 675 | 1.031164 |
| 680 | 1.005 |
| 685 | 0.942532 |
| 690 | 0.850523 |
| 695 | 0.739502 |
| 700 | 0.62 |
| 705 | 0.500707 |
| 710 | 0.382951 |
| 715 | 0.266219 |
| 720 | 0.15 |

FIG. 3E is a graph illustrating the relative quantum efficiency for green leaves interpolated and FIG. 3E is a graph illustrating the relative quantum efficiency for green leaves interpolated and extrapolated beyond the literature data to obtain a complete set of data for wavelengths ranging from 300 to 730 nm. The values used for the graph of FIG. 3E are shown in Table 4 below.

TABLE 4

| | extrapolated |
|---|---|
| 300 | 0.000 |
| 310 | 0.064 |
| 320 | 0.128 |
| 330 | 0.192 |
| 340 | 0.256 |
| 350 | 0.320 |
| 360 | 0.384 |
| 370 | 0.448 |
| 380 | 0.512 |
| 390 | 0.576 |
| 400 | 0.640 |
| 410 | 0.688 |
| 420 | 0.735 |
| 430 | 0.786 |
| 440 | 0.822 |
| 450 | 0.800 |
| 460 | 0.750 |
| 470 | 0.745 |
| 480 | 0.755 |
| 490 | 0.738 |
| 500 | 0.710 |
| 510 | 0.692 |
| 520 | 0.680 |
| 530 | 0.664 |
| 540 | 0.649 |
| 550 | 0.645 |
| 560 | 0.670 |
| 570 | 0.732 |
| 580 | 0.800 |
| 590 | 0.844 |
| 600 | 0.870 |
| 610 | 0.890 |
| 620 | 0.910 |
| 630 | 0.931 |
| 640 | 0.950 |
| 650 | 0.964 |
| 660 | 0.990 |
| 670 | 1.029 |
| 680 | 1.005 |
| 690 | 0.851 |
| 700 | 0.620 |
| 710 | 0.383 |
| 720 | 0.150 |
| 730 | 0.000 |

The invention is further described in the following numbered clauses:

Clause 1: An architectural glass for use in a greenhouse comprising a substrate having a coating, the coating comprising a first dielectric layer, a metal layer over the first dielectric layer, a second dielectric layer over the metal layer, and a first protective overcoat over the second dielectric layer, wherein the first protective overcoat comprises silica and alumina.

Clause 2: The architectural glass of clause 1, wherein the substrate has a first side and a second side, wherein a scattering layer is located on the first side of the substrate and the coating is located on the second side of the substrate.

Clause 3: The architectural glass of clause 2, comprising a second protective overcoat over the scattering layer.

Clause 4: The architectural glass of clause 3, wherein the second protective overcoat comprises silica and alumina.

Clause 5: The architectural glass of any of clauses 1-4, comprising a primer layer over the metal layer.

Clause 6: The architectural glass of any of clauses 1-5, wherein the glass has a photosynthesis efficiency of greater than approximately 88%.

Clause 7: The architectural glass of any of clauses 1-6, wherein the glass has a photosynthesis efficiency of greater than approximately 90%.

Clause 8: The architectural glass of any of clauses 1-7, wherein the glass has a photosynthesis efficiency of greater than approximately 93%.

Clause 9: The architectural glass of any of clauses 1-8, wherein the metal layer comprises a single silver layer.

Clause 10: The architectural glass of clause 9, wherein the silver layer has a thickness of at least 6.5 nm and at most 20 nm.

Clause 11. The architectural glass of any of clauses 1-10, wherein the substrate comprises glass having a total iron as Fe₂O₃ in the range of greater than zero to 0.02 weight percent, wherein the glass has a redox ratio in the range of 0.35 to 0.6.

Clause 12. The architectural glass of any of clauses 1-11, wherein the glass comprises: SiO₂ 65-80 wt. %; Na₂O 10-20 wt. %; CaO 5-15 wt. %; MgO 0-8 wt. %; Al₂O₃ 0-5 wt. %; and K₂O 0-5 wt. %.

Clause 13. The architectural glass of any of clauses 1-12, wherein the architectural glass is a monolithic laminated architectural glass.

Clause 14. The architectural glass of any of clauses 1-13, wherein the architectural glass is used in an insulated glass unit.

Clause 15: The architectural glass of any of clauses 2-4, wherein the scattering layer has a haze of at least 20%.

Clause 16: An architectural insulated glass unit comprising: a first substrate having a No. 1 surface and a No. 2 surface; a second substrate having a No. 3 surface and a No. 4 surface, wherein the second substrate is spaced from the first substrate, and wherein the first and second substrate are associated with each other to define gap therebetween, wherein the No. 2 surface and the No. 3 surface are oppositely disposed from each other and define the gap between the first substrate and the second substrate; a coating located on the No. 2 surface, the No. 3 surface, or the No. 4 surface, the coating comprising a first dielectric layer, a metal layer over the first dielectric layer, a second dielectric layer over the metal layer, and a first protective overcoat over the second dielectric layer, wherein the first protective overcoat comprises silica and alumina.

Clause 17: The architectural insulated glass unit of clause 16, comprising a scattering layer located on at least one of the No. 1, the No. 2, the No. 3, or the No. 4 surface, wherein the scattering layer is located on one of the No. 1, No. 2, No. 3, and No. 4 surface that is different than the surface having the coating thereon.

Clause 18: The architectural insulating glass unit of clause 17, comprising a second protective overcoat over the scattering layer, wherein the second protective overcoat comprises silica and alumina.

Clause 19: The architectural glass of clause 17, wherein the scattering layer has a haze of at least 20%.

Clause 20: The architectural insulated glass unit of any of clauses 16-19, wherein the glass has a photosynthesis efficiency of greater than approximately 88%, greater than approximately 90% or approximately greater than 93%.

Clause 21: The architectural insulated glass unit of any of clauses 16-20, wherein the metal layer comprises a silver layer having a thickness of at least 6.5 nm to at most 20 nm.

Clause 22: The architectural insulating glass unit of any of clauses 16-21, wherein at least one of the first substrate or the second substrate comprises glass, and the glass comprises a total iron as Fe₂O₃ in the range of greater than zero to 0.02 weight percent and comprises a redox ratio in the range of 0.35 to 0.6.

Clause 23: The architectural glass of any of clauses 16-22, wherein the glass comprises: SiO₂ 65-80 wt. %; Na₂O 10-20 wt. %; CaO 5-15 wt. %; MgO 0-8 wt. %; Al₂O₃ 0-5 wt. %; and K₂O 0-5 wt. %.

Clause 24: A method of increasing photosynthesis efficiencies in an insulating glass unit for use in a greenhouse comprising; passing sunlight through an architectural glass comprising a substrate and a coating over at least a portion of the substrate, wherein the coating comprises a first dielectric layer, a metal layer over the first dielectric layer, a second dielectric layer over the metal layer, and a protective overcoat over the second dielectric layer, wherein the first protective overcoat comprises silica and alumina.

Clause 25: The method of clause 24, comprising applying a scattering layer and a second protective overcoat to a surface of the substrate that is opposite to the coating, wherein the second protective overcoat comprises silica and alumina.

Clause 26: The method of clause 24 or 25, wherein the photosynthesis efficiencies of the insulating glass unit is greater than approximately 88%, greater than approximately 90% or greater than approximately 93%.

Clause 27: The method of any of clauses 24-26, comprising applying a slurry mixture to the at least the No. 1, the No. 2 surface, the No. 3 surface, and the No. 4 surface, wherein the slurry mixture comprises a low melting glass frit and a resin-based burn-off component.

Clause 28: The method of any of clauses 24-27, wherein the metal layer comprises a single silver layer applied using a magnetron sputtering vapor deposition (MSVD) coating process.

Clause 29: The method of any of clauses 24-28, wherein the coating comprises primer layer applied using a magnetron sputtering vapor deposition (MSVD) coating process.

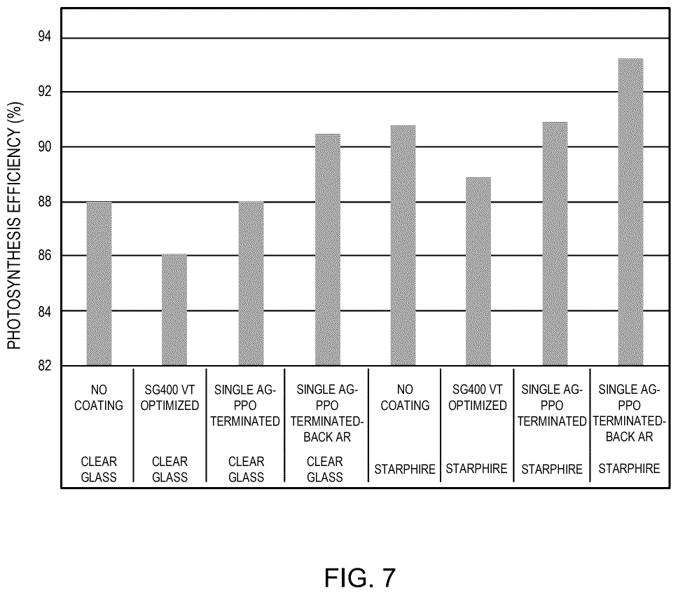

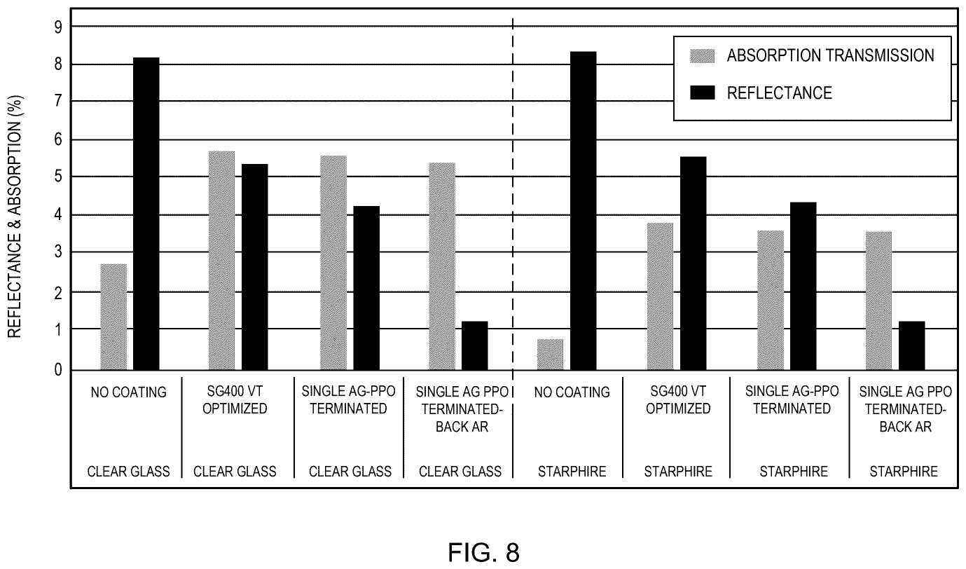

A series of glass substrate samples having different coating profiles, as defined in Examples 1-8 below, were tested to determine their photosynthesis efficiency. A summary of the results of the testing of the various glass substrates is provided in FIG. 7 (photosynthesis efficiency) and FIG. 8 (reflectance and absorption) and in Table 13.

### Example 1

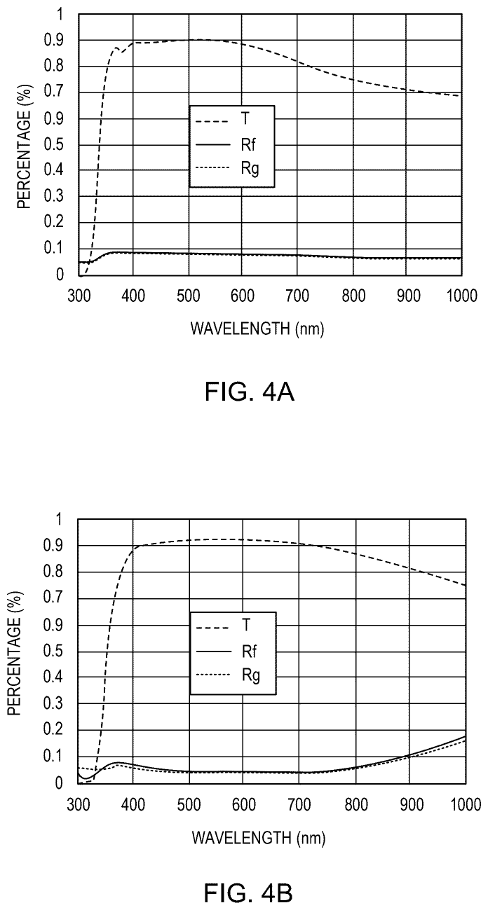

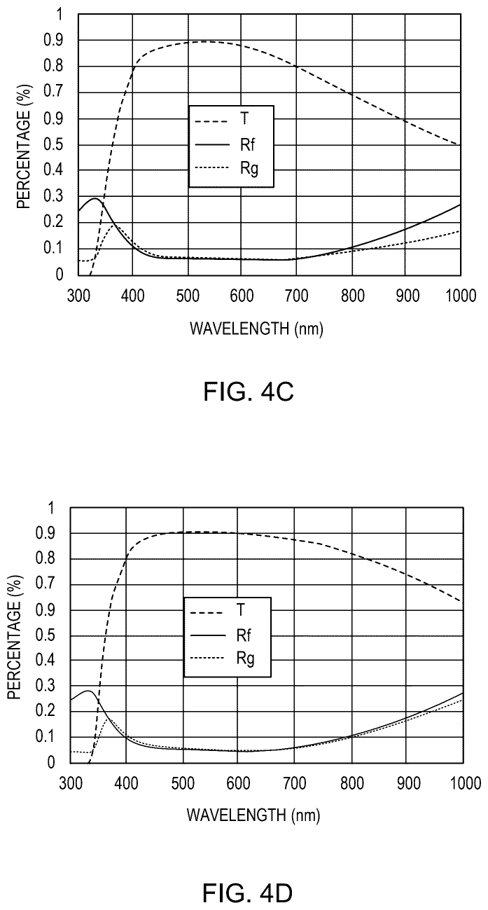

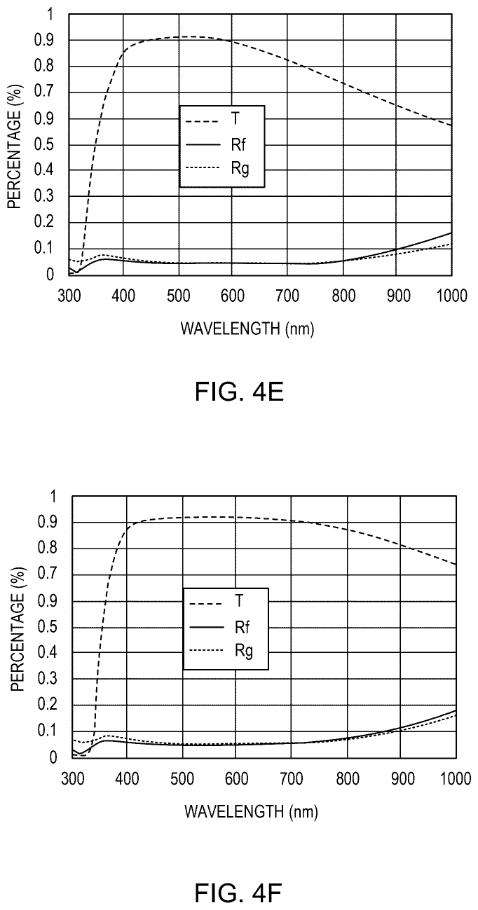

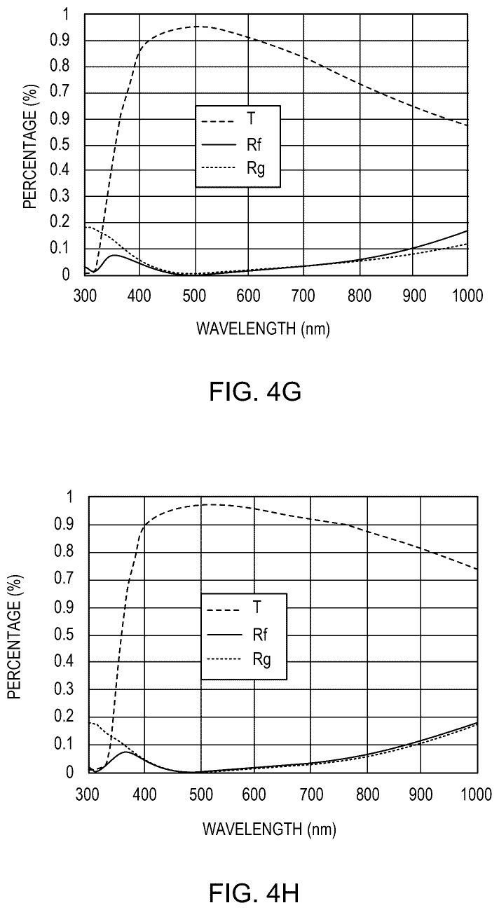

A first comparative example in the form of a clear glass substrate was tested to determine its photosynthesis efficiency using the formula set forth above based on the substrate's reflectance and transmission values in accordance with Table 5 below. A graph illustrating the percentage of transmission T, the reflected color from the film side Rf, and the reflected color from the glass side Rg at various wavelengths are shown in FIG. 4A.

TABLE 5

| | | | thickness |
|---|---|---|---|
| optical | | | (Angstroms |
| properties | values | material | (Å)) |
| Reflectance | 8.1 | Substrate | 5 |
| Transmission | 89.13 | Substrate | 40000000 |
| Photosynthesis | 88.0 | air | 10000000.0 |
| efficiency | | | |
| Transmission | 15.4 | | |
| 60 | | | |
| 8-RfL | 34.3 | | |
| 8-Rfa | −0.7 | | |
| 8-Rfb | −0.8 | | |
| 8-TL | 95.7 | | |
| 8-Ta | −1.4 | | |
| 8-Tb | −0.1 | | |
| 60-RgL | 46.2 | | |
| 60-Rga | −0.8 | | |
| 60-Rgb | −0.6 | | |
| LTA | 88.8 | | |

### Example 2

A second comparative example using a Starphire® glass substrate was tested to determine its photosynthesis efficiency using the formula set forth above based on its reflectance and transmission values in accordance with Table 6 below. A graph illustrating the percentage of transmission T, the reflected color from the film side Rf, and the reflected color from the glass side Rg at various wavelengths are shown in FIG. 4B.

TABLE 6

| optical | | | thickness |
|---|---|---|---|
| properties | values | material | (Å) |
| Reflectance | 8.3 | Substrate | 5 |
| Transmission | 91.1 | Substrate | 40000000 |
| Photosynthesis | 90.8 | air | 10000000.0 |
| efficiency | | | |
| Transmission | 15.7 | | |
| 60 | | | |
| 8-RfL | 34.6 | | |
| 8-Rfa | −0.2 | | |
| 8-Rfb | −0.5 | | |
| 8-TL | 96.4 | | |
| 8-Ta | −0.2 | | |
| 8-Tb | 0.1 | | |
| 60-RgL | 46.6 | | |
| 60-Rga | −0.2 | | |
| 60-Rgb | −0.3 | | |
| LTA | 91.0 | | |

### Example 3

Another example using a Clear-optimized glass substrate having the coating profile set forth below in Table 7 was tested to determine its photosynthesis efficiency using the formula set forth. The reflectance and transmission values for this substrate are also listed in Table 7. A graph illustrating the percentage of transmission T, the reflected color from the film side Rf, and the reflected color from the glass side Rg at various wavelengths are shown in FIG. 4C. Client/Tom-please review the changes to the layer thicknesses, deleting the interface layers and changing the amounts of the neighboring layers.

TABLE 7

| optical | | | thickness |
|---|---|---|---|
| properties | values | material | (Å) |
| Reflectance | 5.4 | Back surface | 5 |
| Transmission | 88.9 | Clear glass | 40000000 |
| Photosynthesis | 86.1 | ZnSn | 394 |
| efficiency | | | |
| Transmission | 76.9 | Zn90 | 81 |
| 60 | | | |
| 8-RfL | 27.8 | Ag | 81 |
| 8-Rfa | −0.3 | TiOx | 36 |
| 8-Rfb | −2.9 | Zn90 | 81 |
| 8-TL | 95.6 | ZnSn | 185 |
| 8-Ta | −1.8 | TiOX | 45.65 |
| 8-Tb | 1.0 | Air | 100000.0 |
| 60-TL | 90.3 | | |
| 60-Ta | −1.7 | | |
| 60-Tb | 0.2 | | |
| LTA | 88.6 | | |

### Example 4

Another example using a Starphire®-optimized glass substrate, having the coating profile set forth below in Table 8, was tested to determine its photosynthesis efficiency using the formula set forth above. The reflectance and transmission values for this substrate are also listed in Table 8. A graph illustrating the percentage of transmission T, the reflected color from the film side Rf, and the reflected color from the glass side Rg at various wavelengths are shown in FIG. 4D.

TABLE 8

| optical | | | thickness |
|---|---|---|---|
| properties | values | material | (Å) |
| Reflectance | 5.5 | Back surface | 5 |
| Transmission | 90.7 | Starphire | 40000000 |
| Photosynthesis | 88.9 | ZnSn | 394 |
| efficiency | | | |
| Transmission | 78.8 | Zn90 | 81 |
| 60 | | | |
| 8-RfL | 28.2 | Ag | 81 |
| 8-Rfa | 0.4 | TiOx | 37 |
| 8-Rfb | −2.6 | Zn90 | 81 |
| 8-TL | 96.3 | ZnSn | 188 |
| 8-Ta | 0.6 | TiOX | 61 |
| 8-Tb | 1.2 | Air | 100000.0 |
| 60-TL | 91.2 | | |
| 60-Ta | −0.3 | | |
| 60-Tb | 0.5 | | |
| LTA | 90.8 | | |

### Example 5

Another example using a single silver-silica/alumina terminated/clear glass substrate, having the coating profile set forth below in Table 9, was tested to determine its photosynthesis efficiency using the formula set forth above. The reflectance and transmission values for this substrate are also listed in Table 9. A graph illustrating the percentage of transmission T, the reflected color from the film side Rf, and the reflected color from the glass side Rg at various wavelengths are shown in FIG. 4E.

TABLE 9

| optical | | | thickness |
|---|---|---|---|
| properties | values | material | (Å) |
| Reflectance | 4.2 | Back surface | 5 |
| Transmission | 90.2 | Clear | 40000000 |
| Photosynthesis | 88.1 | ZnSn | 343 |
| efficiency | | | |
| Transmission | 79.2 | Zn90 | 81 |
| 60 | | | |
| 8-RfL | 24.3 | Ag | 67 |
| 8-Rfa | −1.2 | TiOx | 37 |
| 8-Rfb | −0.4 | Zn90 | 81 |
| 8-TL | 96.1 | ZnSn | 90 |
| 8-Ta | −1.6 | silica/alumina | 550 |
| 8-Tb | 0.4 | Air | 100000.0 |
| 60-TL | 91.3 | | |
| 60-Ta | −1.7 | | |
| 60-Tb | −0.7 | | |
| LTA | 89.8 | | |

### Example 6

An example using a single silver silica/alumina terminated/Starphire® glass substrate, having the coating profile set forth below in Table 10, was tested to determine its photosynthesis efficiency using the formula set forth above. The reflectance and transmission values for this substrate are also listed in Table 10. A graph illustrating the percentage of transmission T, the reflected color from the film side Rf, and the reflected color from the glass side Rg at various wavelengths are shown in FIG. 4F.

TABLE 10

| optical | | | thickness |
|---|---|---|---|
| properties | values | material | (Å) |
| Reflectance | 4.4 | Back surface | 5 |
| Transmission | 92.0 | Starphire | 40000000 |
| Photosynthesis | 90.9 | ZnSn | 343 |
| efficiency | | | |
| Transmission | 81.1 | Zn90 | 81 |
| 60 | | | |
| 8-RfL | 24.8 | Ag | 67 |
| 8-Rfa | −0.4 | TiOx | 36 |
| 8-Rfb | −0.1 | Zn90 | 81 |
| 8-TL | 96.8 | ZnSn | 90 |
| 8-Ta | −0.4 | silica/alumina | 551 |
| 8-Tb | 0.7 | Air | 100000.0 |
| 60-TL | 92.2 | | |
| 60-Ta | −0.2 | | |
| 60-Tb | −0.4 | | |
| LTA | 92.0 | | |

### Example 7

An example using a single silver silica/alumina terminated-back anti-reflective layer using a clear glass, having the coating profile set forth below in Table 11, was tested to determine its photosynthesis efficiency using the formula set forth above. The reflectance and transmission values for this substrate are also listed in Table 11. A graph illustrating the percentage of transmission T, the reflected color from the film side Rf, and the reflected color from the glass side Rg at various wavelengths are shown in FIG. 4G. Reference is also made to FIG. 5, which shows the various layers of the coating profile of this glass substrate used in this Example and is discussed in more detail below.

TABLE 11

| optical | | | thickness |
|---|---|---|---|
| properties | values | material | (Å) |
| Reflectance | 1.2 | silica/alumina | 1130 |
| Transmission | 93.4 | ZnSn | 102 |
| Photosynthesis | 90.4 | Back Surfase | 5 |
| efficiency | | | |
| Transmission | 80.5 | Clear | 40000000.0 |
| 60 | | | |
| 8-RfL | 10.5 | ZnSn | 345 |
| 8-Rfa | 11.4 | Zn90 | 81 |
| 8-Rfb | 1.5 | Ag | 67.85 |
| 8-TL | 97.4 | TiOx | 20.2 |
| 8-Ta | −2.5 | Zn90 | 3 |
| 8-Tb | 0.3 | ZnSn | 80 |
| 60-TL | 91.9 | silica/alumina | 88 |
| 60-Ta | −1.9 | Air | 100000.0 |
| 60-Tb | −2.6 | | |
| LTA | 92.7 | | |

### Example 8

An example using a single silver silica/alumina terminated-back anti-reflective layer using a Starphire® glass, having the coating profile set forth below in Table 12, was tested to determine its photosynthesis efficiency using the formula set forth above. The reflectance and transmission values for this substrate are also listed in Table 12. A graph illustrating the percentage of transmission T, the reflected color from the film side Rf, and the reflected color from the glass side Rg at various wavelengths are shown in FIG. 4H. Reference is also made to FIG. 6, which shows the various layers of the coating profile of this glass substrate used in this Example and is discussed in more detail below.

TABLE 12

| optical | | | thickness |
|---|---|---|---|
| properties | values | Material | (Å) |
| Reflectance | 1.2 | silica/alumina | 1135 |
| Transmission | 95.3 | ZnSn | 101 |
| Photosynthesis | 93.3 | Back Surface | 5 |
| efficiency | | | |
| Transmission | 82.5 | Clear | 40000000.0 |
| 60 | | | |
| 8-RfL | 10.7 | ZnSn | 345 |
| 8-Rfa | 12.2 | Zn90 | 81 |
| 8-Rfb | 1.2 | Ag | 66 |
| 8-TL | 98.1 | TiOx | 36 |
| 8-Ta | −1.3 | Zn90 | 81 |
| 8-Tb | 0.6 | ZnSn | 88 |
| 60-TL | 92.8 | silica/alumina | 552.7 |
| 60-Ta | −0.4 | Air | 100000.0 |
| 60-Tb | −2.2 | | |
| LTA | 95.0 | | |

Reference is now made to FIG. 5, which illustrates the coating profile of one embodiment of a glass structure 10a using a glass substrate 12a, as set forth in Table 11 of Example 7. The glass substrate 12a comprises a clear glass. The anti-reflective or scattering layer 18 can be located on the first side 14a of the substrate 12a. A protective layer 58 is provided adjacent to the anti-reflective layer 18. The second side 16a of the substrate 12a includes the low-e coating 20a. This low-e coating 20a includes a first dielectric layer 60, a single silver layer 62, a primer layer 64, and a second dielectric layer 66, followed by a protective layer 68. The primer layer 64 can be any known primer layer, such as titanium dioxide and the like, the first and second dielectric layers 60, 66 can be any known dielectric layer, such as a zinc based alloy or the like, and the protective overcoat layers 58, 68 can be any known protective material, such as titania, silica, mixtures thereof, and the like. According to one embodiment, the protective overcoat layers 58, 68 can be a silica/alumina, such as 85% silica/15% alumina. It has been surprisingly found that this particular coating profile using clear glass has a photosynthesis efficiency of at least approximately 90% or higher, i.e., approximately 90.4%.

Reference is now made to FIG. 6, which illustrates the coating profile of another embodiment of a glass structure 10b including a glass substrate 12b, as set forth in Table 12 of Example 8. This embodiment differs from the embodiment shown in FIG. 5 in that the glass substrate 12b comprises a Starphire® glass. The anti-reflective or scattering layer 18 can be located on the first side 14 of the substrate 12. A protective layer 58 is provided adjacent to the anti-reflective layer 18b. The second side 16b of the substrate 12b includes the low-e coating layer 20b. This low-e coating layer 20b includes a first dielectric layer 60, a single silver layer 62, a primer layer, and a second dielectric layer 66, followed by a protective layer 68. The primer layer 64 can be any known primer layer, such as titanium dioxide and the like, the first and second dielectric layers 60, 66 can be any known dielectric layer, such as a zinc-based alloy or the like, and the protective layers 58, 68 can be any known protective material, such as titania, silica, mixtures thereof, and the like. It has been surprisingly found that this particular coating profile using Starphire® glass has a photosynthesis efficiency of at least approximately 93% or higher, i.e., approximately 93.3%.

It is noted that the substrates 12a, 12b, shown in FIGS. 5 and 6, can be used as one of the substrates 32, 38 in an insulating glass unit 30, (referring back to FIGS. 2A and 2B) keeping in mind that the low-e layer 50 should be located on the No. 2 surface 36 or the No. 3 surface 40. The scattering layer 48 can be on any of or more than one of the No. 1 surface 34, No. 2 surface 36, No. 3 surface 40, or No. 4 surface 42, but not on the same surface as the low-e layer 50.

Reference is made to FIGS. 7 and 8, which summarize the results found during testing of Examples 1-8. FIG. 7 shows that a clear glass substrate having a single silver low-e layer on a No. 2 surface surprisingly results in glass that promotes the same level of plant growth as a clear glass substrate. FIG. 7 also shows that adding an anti-reflective layer on a No. 1 surface further increases the photosynthesis efficiency of the glass to over 90%. Regarding the use of Starphire glass, the test results also surprisingly showed that providing a single silver low-e layer on a No. 2 surface results in a glass that has approximately the same photosynthesis efficiency as an uncoated Starphire glass and that adding an anti-reflective layer to the No. 1 surface increases the photosynthesis efficiency to over 93%.

FIG. 8 shows that adding a single silver layer to a No. 2 surface increases the absorption of the glass article by about 3% and a properly optimized coating reduces the reflection by about 4%, resulting in similar photosynthesis efficiency. It has also been found and is shown in FIG. 8 that adding an anti-reflective layer on the No. 1 surface reduces the reflectance by another 3% and increases the photosynthesis efficiency by approximately 2%. Starphire glass (4 mm) has about 1.9% less absorption than clear glass.

Table 13 below summarizes the photosynthesis efficiency, reflectance, transmission, and absorption of the substrates discussed above in Examples 1-8.

TABLE 13

| | | Photosynthesis | | | | RF | | | T | | |
|---|---|---|---|---|---|---|---|---|---|---|---|
| | 4 mm glass in all cases | Efficiency (%) | Reflectance | Transmission | Absorption | L* | a* | b* | L* | a* | b* |
| Air | | 100.00 | — | — | — | — | — | — | — | — | — |
| Clear glass | No coating | 88.0 | 8.2 | 89.3 | 2.6 | 34.3 | −0.7 | −0.8 | 95.7 | −1.4 | −0.1 |
| Starphire | No coating | 90.8 | 8.3 | 91.0 | 0.7 | 34.6 | −0.2 | −0.5 | 96.4 | −0.2 | 0.1 |
| Clear glass | SG400 VT optimized | 86.1 | 5.4 | 88.9 | 5.7 | 27.8 | −0.3 | −2.9 | 95.6 | −1.8 | 1.0 |
| Starphire | SG400 VT optimized | 88.9 | 5.5 | 90.7 | 3.8 | 28.2 | 0.4 | −2.6 | 96.3 | −0.6 | 1.2 |
| Clear glass | single Ag- silica/alumina | 88.1 | 4.2 | 90.2 | 5.6 | 24.3 | −1.2 | −0.4 | 96.1 | −1.6 | 0.4 |
| | terminated | | | | | | | | | | |
| Starphire | single Ag- silica/alumina | 90.9 | 4.4 | 92.0 | 3.6 | 24.8 | −0.4 | −0.1 | 96.8 | −0.4 | 0.7 |
| | terminated | | | | | | | | | | |
| Clear glass | single Ag- silica/alumin | 90.4 | 1.2 | 93.4 | 5.4 | 10.5 | 11.4 | 1.5 | 97.4 | −2.5 | 0.3 |
| | terminated- back AR | | | | | | | | | | |
| Starphire | single Ag- silica/alumina | 93.3 | 1.2 | 95.3 | 3.5 | 10.7 | 12.2 | 1.2 | 98.1 | −1.3 | 0.6 |
| | terminated- back AR | | | | | | | | | | |

In accordance with another aspect, the present disclosure is directed to a method for forming an insulating glass unit 30a, 30b for use in a greenhouse. The method comprises providing a first substrate 32 having a No. 1 surface 34 and a No. 2 surface 36 and providing a second substrate 38 having a No. 3 surface 40 and a No. 4 surface 42. The method further comprises forming a scattering layer 48 on at least one of the No. 1 surfaces 34, the No. 2 surface 36, the No. 3 surface 40, and the No. 4 surface 42. The scattering layer can be an anti-reflective scattering layer having a haze of at least 20%. The method also comprises applying a coating 50 to at least one of the No. 2 surfaces 36, No. 3 surface 40, or the No. 4 surface 42, wherein the coating 50 comprises a low-e coating. The method then comprises associating the first substrate 32 with the second substrate 38 to form a unit, wherein the first substrate 32 is spaced from the second substrate 38 to form a gap 46 therebetween, wherein the No. 2 surface 36 and the No. 3 surface 40 are oppositely disposed from each other and define the gap 46 between the first substrate 32 and the second substrate 38. The method further comprises filling the gap 36 with at least one of air and a non-reactive gas. According to another embodiment, the gap 46 may be evacuated to produce a vacuum (a vacuum-insulating glass unit). The coating profile of the present application is configured to maximize and achieve uniform plant growth.

According to one embodiment, and as discussed in detail above in the Examples, Tables, and FIGS. 7 and 8, the architectural insulating glass unit can have a photosynthesis efficiency of greater than approximately 88%, greater than approximately 90%, or greater than approximately 93%.

According to one embodiment, a scattering or protective layer 22 (FIG. 1), 52 (FIG. 2B) can be provided. This scattering or protective layer can comprise a slurry of low-melting glass frit and a resin-based burn-off component. In FIG. 1, this scattering or protective coating 22 can be applied adjacent to the low-e coating layer 20 on the No. 2 surface to protect this low-e coating layer 20. In FIG. 2B, this scattering or protective layer 52 can be applied to the No. 4 surface 42. However, it can be appreciated that the scattering or protective layer 52 can be applied to any or all of the No. 1 surface 34, the No. 2 surface 36, the No. 3 surface 40, and/or the No. 4 surface 42. However, if the scattering or protective layer 52 is to be used in an insulating glass unit 30a, 30b, as in FIGS. 2A and 2B, the scattering or protective layer 52 will typically not be applied adjacent to the low-e coating 50 on either the No. 2 surface 36 or the No. 3 surface 40. It can be appreciated that the anti-reflective scattering layer 8 can be formed by a variety of methods, such as applying a coating/nanoparticle mixture to the glass surface, applying a nanoparticle layer to a coated surface such that the nanoparticles become embedded therein, laser etching a coating or the glass surface itself, and/or any other known techniques for creating an anti-reflective surface.

According to one embodiment, the coating layer 50 can comprise a single silver layer and can be applied using a magnetron sputtering vapor deposition (MSVD) coating process. It can be appreciated that other coating methods, known in the art, can be used to apply the silver layer. Referring to FIGS. 5 and 6, the coating layer 20a, 20b, 50 can further include at least one of a primer layer 64 and one or more dielectric layers 60, 66. A protective overcoat 58, 68 can be applied over the scattering layer 48, the coating 20a, 20b, 50, or both. All or some of these layers can be applied using known coating techniques, such as a magnetron sputtering vapor deposition (MSVD) coating process.

It will be readily appreciated by those skilled in the art that modifications may be made to the invention without departing from the concepts disclosed in the foregoing description. Accordingly, the particular embodiments described in detail herein are illustrative only and are not limited to the scope of the invention, which is to be given the full breadth of the appended claims and any and all equivalents thereof.

The invention claimed is:

1. An architectural glass for use in a greenhouse comprising a substrate having a coating, the coating comprising a first dielectric layer, a metal layer over the first dielectric layer, a second dielectric layer over the metal layer, and a first protective overcoat over the second dielectric layer, wherein the first protective overcoat comprises silica and alumina.

2. The architectural glass of claim 1, wherein the substrate has a first side and a second side, wherein a scattering layer is located on the first side of the substrate and the coating is located on the second side of the substrate.

3. The architectural glass of claim 2, comprising a second protective overcoat over the scattering layer.

4. The architectural glass of claim 3, wherein the second protective overcoat comprises silica and alumina.

5. The architectural glass of claim 1, comprising a primer layer over the metal layer.

6. The architectural glass of claim 1, wherein the glass has a photosynthesis efficiency of greater than approximately 88%.

7. The architectural glass of claim 6, wherein the glass has a photosynthesis efficiency of greater than approximately 90%.

8. The architectural glass of claim 7, wherein the glass has a photosynthesis efficiency of greater than approximately 93%.

9. The architectural glass of claim 1, wherein the metal layer comprises a single silver layer.

10. The architectural glass of claim 9, wherein the silver layer has a thickness of at least 6.5 nm and at most 20 nm.

11. The architectural glass of claim 1, wherein the architectural glass is a monolithic laminated architectural glass.

12. The architectural glass of claim 1, wherein the architectural glass is used in an insulated glass unit.

13. An architectural insulated glass unit comprising:
a first substrate having a No. 1 surface and a No. 2 surface;
a second substrate having a No. 3 surface and a No. 4 surface, wherein the second substrate is spaced from the first substrate, and wherein the first and second substrate are associated with each other to define gap therebetween, wherein the No. 2 surface and the No. 3 surface are oppositely disposed from each other and define the gap between the first substrate and the second substrate;
a coating located on the No. 2 surface, the No. 3 surface, or the No. 4 surface, the coating comprising a first dielectric layer, a metal layer over the first dielectric layer, a second dielectric layer over the metal layer, and a first protective overcoat over the second dielectric layer, wherein the first protective overcoat comprises silica and alumina.

14. The architectural insulated glass unit of claim 13, comprising a scattering layer located on at least one of the No. 1, the No. 2, the No. 3, or the No. 4 surface, wherein the scattering layer is located on one of the No. 1, No. 2, No. 3, and No. 4 surface that is different than the surface having the coating thereon.

15. The architectural insulating glass unit of claim 14, comprising a second protective overcoat over the scattering layer, wherein the second protective overcoat comprises silica and alumina.

16. The architectural insulated glass unit of claim 15, wherein the glass has a photosynthesis efficiency of greater than approximately 88%, greater than approximately 90% or approximately greater than 93%.

17. The architectural insulated glass unit of claim 14, wherein the metal layer comprises a silver layer having a thickness of at least 6.5 nm to at most 20 nm.

18. A method of increasing photosynthesis efficiencies in an insulated glass unit for use in a greenhouse comprising;
passing sunlight through an architectural glass comprising a substrate and a coating over at least a portion of the substrate, wherein the coating comprises a first dielectric layer, a metal layer over the first dielectric layer, a second dielectric layer over the metal layer, and a protective overcoat over the second dielectric layer, wherein the first protective overcoat comprises silica and alumina.

19. The method of claim 18, comprising applying a scattering layer and a second protective overcoat to a surface of the substrate that is opposite to the coating, wherein the second protective overcoat comprises silica and alumina.

20. The method of claim 18, wherein the photosynthesis efficiencies of the insulated glass unit is greater than approximately 88%, greater than approximately 90% or approximately greater than 93%.
